(19) United States
(12) Patent Application Publication
(10) Pub. No.: US 2019/0005125 A1
(43) Pub. Date: Jan. 3, 2019

(54) CATEGORIZING ELECTRONIC CONTENT

(71) Applicant: Microsoft Technology Licensing, LLC, Redmond, WA (US)

(72) Inventors: Dong YOO, Issaquah, WA (US); Philipp CANNONS, Seattle, WA (US)

(21) Appl. No.: 15/637,753

(22) Filed: Jun. 29, 2017

(51) Int. Cl. G06F 17/30; G06Q 50/00; G06Q 10/10

(52) U.S. Cl. CPC G06F 17/30705; G06Q 50/01; G06N 99/005; G06F 17/30722; G06Q 10/107

(57) ABSTRACT

Systems, methods and apparatus for categorizing electronic content. In one example, the system, method, and apparatus include receiving electronic content items; analyzing textual data and metadata associated with the electronic content items; generating a project workspace based on information associated with one selected from a group consisting of a user of the computing device, the electronic content items, textual data and metadata associated with the electronic content items; categorizing the electronic content items into the project workspace based on intrinsic data and extrinsic data associated with the user; and displaying the project workspace and the electronic content items associated with the project workspace.

### FIELD

Embodiments described herein relate to systems and methods for categorizing electronic content.

### BACKGROUND

With the increased usage of electronic message systems, it has become difficult for users of such systems to track electronic content. This is particularly true when the volume of electronic content is high. For example, in any given day, a person may receive tens or even hundreds of emails, documents, instant messaging communication threads, tasks, electronic meeting notifications, calendar items, etc. that may be associated with various projects and project teams. In such instances, a user is often unable to organize and categorize the electronic content due to time constraints.

### SUMMARY

Currently available electronic message systems (for example, email classifying programs) do not automatically categorize electronic content into project workspaces based on a user's behaviors (intrinsic data) and/or characteristics associated with electronic content, and the user's actions within social groups (extrinsic data).

Systems and methods are provided herein that, among other things, categorizes various electronic communications and content associated with a user into clusters within project workspaces based on several rules using a machine-learning engine. In some embodiments, if a group of users communicate often about a particular project (for example, Project X) a lot, then a project workspace for Project X is created. Once the project workspace for Project X is created, all electronic content (such as emails/documents) related to Project X will be automatically categorized and classified as belonging to Project X and will be available in a private space for them to be displayed to the users working on Project X.

One embodiment provides a computing device comprising a display device displaying a graphical user interface. The computing device also includes a memory having processor-executable instructions and an electronic processor operatively coupled to the display and the memory. The electronic processor is configured to execute the processor-executable instructions to receive an electronic content item associated with an electronic message; analyze textual data and metadata associated with the electronic content item and the electronic message; generate a project workspace based on information associated with one selected from a group consisting of a user of the computing device, the electronic content item and the electronic message; categorize the electronic content item into the project workspace based on extrinsic data and intrinsic data associated with the user; and display the project workspace in the graphical user interface.

Another embodiment provides a method for categorizing electronic content. The method includes receiving, with an electronic processor, a first plurality of electronic content items associated with a first plurality of electronic messages. The method also includes analyzing, with the electronic processor, textual data and metadata associated with the first plurality of electronic content items and the first plurality of electronic messages. The method also includes generating, with the electronic processor, a project workspace based on information associated with one selected from the group consisting of a user of the computing device, the first plurality of electronic content items, textual data and metadata associated with the first plurality of electronic content items, and the first plurality of electronic messages. The method also includes categorizing, with the electronic processor, the first plurality of electronic content item into the project workspace based on intrinsic data and extrinsic data associated with the user; and displaying the project workspace, a second plurality of electronic content items and a second plurality of electronic messages associated with the project workspace.

Another embodiment provides a non-transitory computer-readable medium containing computer-executable instructions that when executed by one or more processors cause the one or more processors to receive an electronic content item; analyze textual data and metadata associated with the electronic content item; generate a project workspace based on one selected from a group consisting of information associated with a user of the computing device, the textual data associated with the electronic content item, and metadata associated with the electronic content item; categorize the electronic content item into the project workspace; and display the project workspace.

Other aspects of the various embodiments provided herein will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates a system for providing electronic content classification, in accordance with some embodiments.

FIG. 2 illustrates a block diagram of the computing device shown in FIG. 1, in accordance with some embodiments.

FIG. 3 illustrates various software programs stored in the memory shown in FIG. 2, in accordance with some embodiments.

FIG. 4 illustrates a graphical user interface of an electronic messaging application, in accordance with some embodiments.

FIG. 5 is a block diagram illustrating an association between a number of electronic content repositories and one or more electronic project workspaces via a project classification system.

FIG. 6 illustrates a system architecture and process flow associated with automatically classifying electronic content into one or more electronic project workspaces.

FIG. 7 is a flow chart of a method for categorizing electronic content, in accordance with some embodiments.

FIG. 8 illustrates a graphical user interface of an electronic messaging application, in accordance with some embodiments.

FIG. 9 illustrates a graphical user interface of an electronic messaging application, in accordance with some embodiments.

FIG. 10 illustrates a graphical user interface of an electronic messaging application, in accordance with some embodiments.

FIG. 11 illustrates a graphical user interface of an electronic messaging application, in accordance with some embodiments.

FIG. 12 illustrates a graphical user interface of an electronic messaging application, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments provided herein.

The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. It should also be noted that a plurality of hardware and software based devices may be utilized to implement various embodiments.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Some embodiments may include other computer system configurations, including hand-held devices, multiprocessor systems and distributed computing environments where tasks are performed by remote processing devices that are linked through a communications network. In a distributed environment, program modules may be located in both local and remote memory storage devices.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

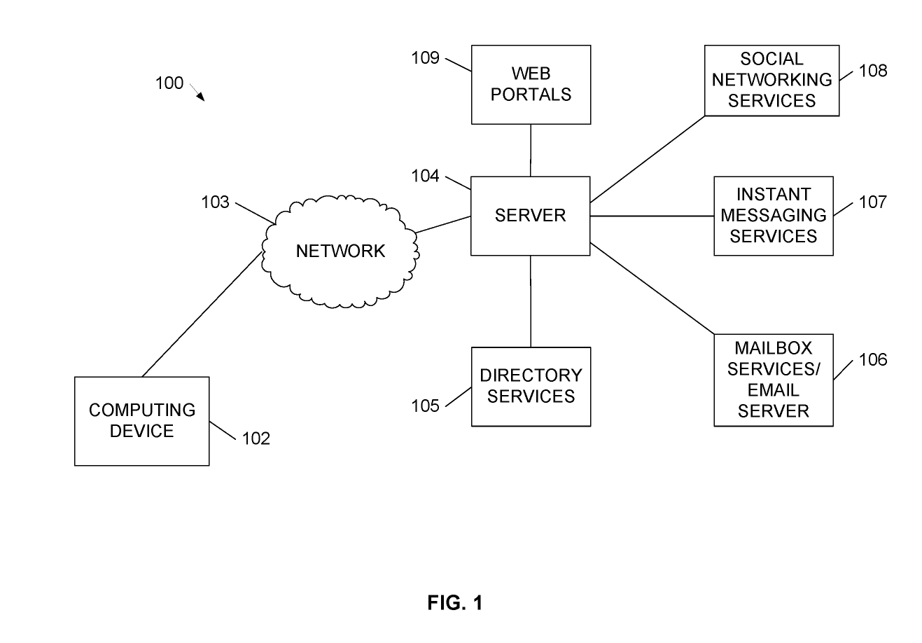

FIG. 1 illustrates a system 100 for providing content classification, in accordance with some embodiments. System 100 may be utilized for classifying content items into one or more project workspaces received via a variety of communication channels via a communication network 103. System 100 includes a computing device 102 in communication with a server 104 via the communication network 103. In some embodiments, the server 104 provides content item classification to various clients (for example, computing device 102). Information and features helpful in classifying content items into one or more project workspaces may be available through a variety of services accessible via the server 104. For example, received content items and associated metadata or feature information may be stored using directory services 105, mailbox services or email server 106, instant messaging services 107, social networking services 108, and web portals 109.

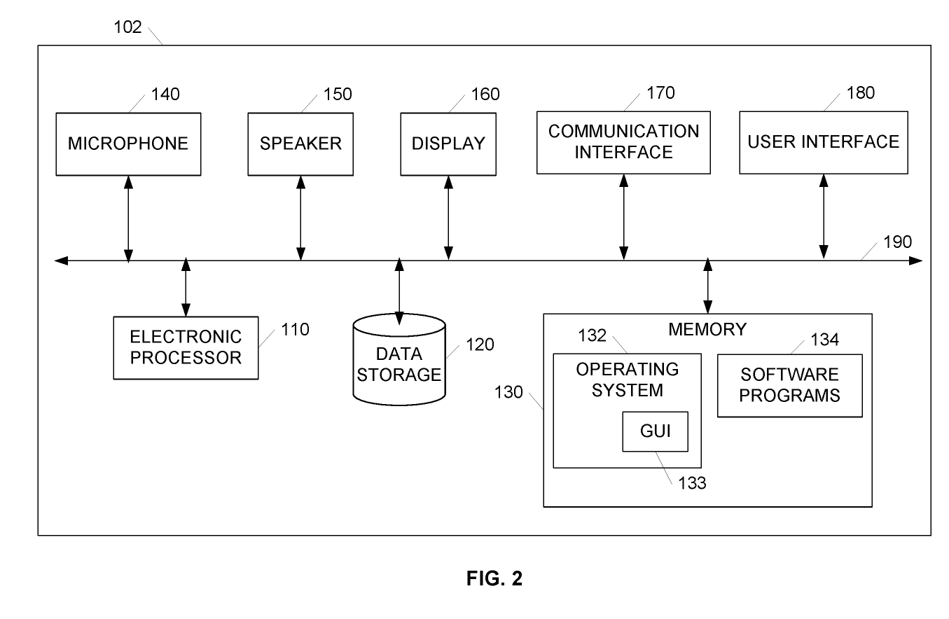

FIG. 2 illustrates a block diagram of the computing device 102 shown in FIG. 1, in accordance with some embodiments. The computing device 102 may combine hardware, software, firmware, and system on-a-chip technology to implement the method of authoring an electronic message as provided herein. In some embodiments, the computing device 102 includes an electronic processor 110, a data storage device 120, a memory 130, a microphone 140, a speaker 150, a display-device 160, a communication interface 170, a user interface 180 that can include a variety of components for example, an electronic mouse, a keyboard, a trackball, a stylus, a touch-pad, a touchscreen, a display, and others. The computing device 102 also includes a bus 190 that interconnects the components of the device.

In the example illustrated, the memory 130 includes an operating system 132 and one or more software programs 134. In some embodiments, the operating system 132 includes a graphical user interface (GUI) program (or generator) 133 that provides a graphical human-computer interface on a display, for example, a display that is part of the user interface 180. The graphical user interface generator 133 may cause an interface to be displayed that includes icons, menus, text, and other visual indicators or graphical representations to display information and related user controls. In some embodiments, the graphical user interface generator 133 is configured to interact with a touchscreen to provide a touchscreen-based user interface 180. In one embodiment, the electronic processor 110 may include at least one microprocessor and be in communication with at least one microprocessor. The microprocessor interprets and executes a set of instructions stored in the memory 130. The one or more software programs 134 may be configured to implement the methods described herein. In some embodiments, the memory 130 includes, for example, random access memory (RAM), read-only memory (ROM), and combinations thereof. In some embodiments, the memory 130 has a distributed architecture, where various components are situated remotely from one another, but may be accessed by the electronic processor 110.

The data storage device 120 may include a non-transitory, machine-readable storage medium that stores, for example, one or more databases. In one example, the data storage device 120 also stores executable programs, for example, a set of instructions that when executed by one or more processors cause the one or more processors to perform the one or more methods describe herein. In one example, the data storage device 120 is located external to the computing device 102.

The communication interface 170 provides the computing device 102 a communication gateway with an external network (for example, a wireless network, the internet, etc.). The communication interface 170 may include, for example, an Ethernet card or adapter or a wireless local area network (WLAN) integrated circuit, card or adapter (for example, IEEE standard 802.11a/b/g/n). The communication interface 170 may include address, control, and/or data connections to enable appropriate communications with the external network.

The user interface 180 provides a mechanism for a user to interact with the computing device 102. As noted above, the user interface 180 includes input devices such as a keyboard, a mouse, a touch-pad device, and others. In some embodiments, the display 160 may be part of the user interface 180 and may be a touchscreen display. In some embodiments, the user interface 180 may also interact with or be controlled by software programs including speech-to-text and text-to-speech interfaces. In some embodiments, the user interface 180 includes a command language interface, for example, a software-generated command language interface that includes elements configured to accept user inputs, for example, program-specific instructions or data. In some embodiments, the software-generated components of the user interface 180 includes menus that a user may use to choose particular commands from lists displayed on the display 160.

The bus 190, or other component interconnection, provides one or more communication links among the components of the computing device 102. The bus 190 may be, for example, one or more buses or other wired or wireless connections. The bus 190 may have additional elements, which are omitted for simplicity, such as controllers, buffers (for example, caches), drivers, repeaters, and receivers, or other similar components, to enable communications. The bus 190 may also include address, control, data connections, or a combination of the foregoing to enable appropriate communications among the aforementioned components.

In some embodiments, the electronic processor 110, the display 160, and the memory 130, or a combination thereof may be included in one or more separate devices. For example, in some embodiments, the display may be included in the computing device 102 (for example, a portable communication device such as a smart phone, tablet, etc.), which is configured to transmit an electronic message to the server 104 including the memory 130 and one or more other components illustrated in FIG. 2. In this configuration, the electronic processor 110 may be included in the portable communication device or another device that communicates with the server 104 over a wired or wireless network or connection.

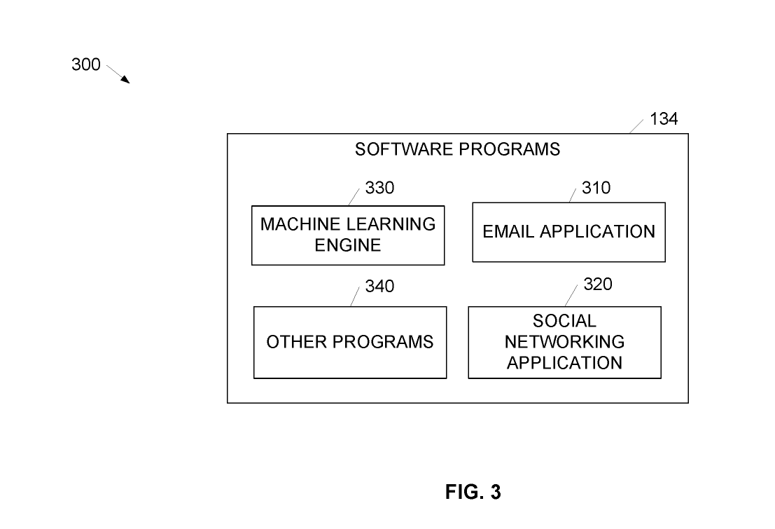

FIG. 3 illustrates various software programs stored in the memory shown in FIG. 2, in accordance with some embodiments. In the example shown, the software programs 134 include an email application 310, a social network application 320, a machine learning engine 330, and other programs 340. In some embodiments, the electronic processor 110 executes the software programs 134 that are locally stored in the memory 130 of the computing device 102 to perform the methods described herein. For example, the electronic processor 110 may execute the software programs 134 to access and process data (for example, electronic messages, user profile, etc.) stored in the memory 130 and/or the data storage device 120. Alternatively or in addition, the electronic processor 110 may execute the software programs 134 to access data (for example, electronic messages) stored external to the computing device 102 (for example, on the server 104 accessible over a communication network 103 such as the internet). The electronic processor 110 may output the results of processing to the display 160 included in the computing device 102.

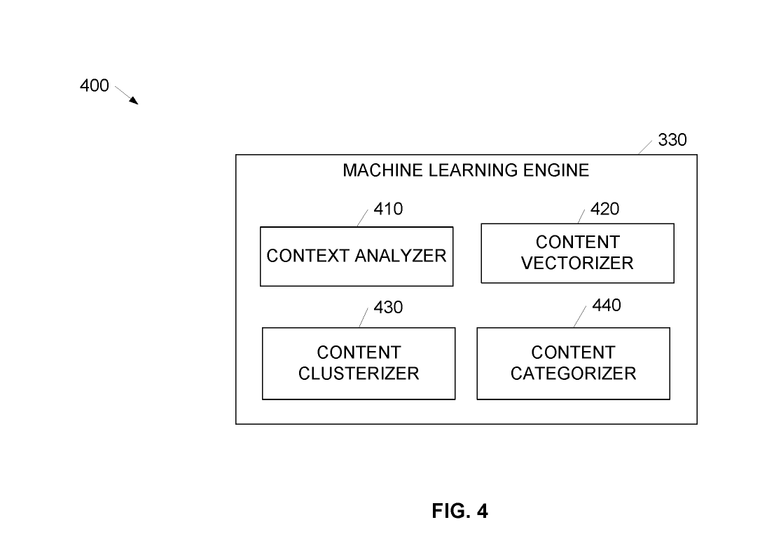

FIG. 4 is a block diagram of a machine-learning engine 330 shown in FIG. 3, in accordance with some embodiments. In some embodiments, the machine-learning engine 330 includes a context analyzer 410, a content vectorizer 420, a content clusterizer 430, and a content categorizer 440.

In some embodiments, the context analyzer 410 receives electronic content (for example, emails, text messages, etc.) and analyzes the electronic content based on intrinsic and extrinsic data associated with a user. In some embodiments, the intrinsic data includes data related to a characteristic associated with the user. In some embodiments, the intrinsic data includes data associated with the relationships between several pieces of electronic content related to the behavior of the user. In some embodiments, the intrinsic data includes data associated with the actions taken by the user within a social group associated with the user or with a social group that user group has participated in or contributed to. For example, the behavior and/or characteristics of a user performing the function as a project manager might include having the user being responsible for periodically sending out a project plan to a group. In some embodiments, the extrinsic data includes data associated with behaviors and/or actions taken by the user within a particular social group.

In some embodiments, the content vectorizer 420 is configured to gather word frequencies (or term frequencies) associated with a particular text and generates vectors corresponding to the respective text. This is accomplished by looking at co-occurring pairs of words and then encoding the probability of them occurring within the same sentence, paragraph, inversely diminished by the words' distance from each other. This allows for a small dimensionality representation of the words' semantic meaning through numerical vectors which can be then joined to the input of the machine learning model, to be treated as any other conventional input which can be mathematically formulated.

In some embodiments, the content clusterizer 430 is configured to look at sequences of events that frequently occur in a pattern descriptive of the underlying user intent. By observing the interplay of the content through the content vectorizer 420 and the clusters of sequences we can observe task frequency and probability of occurrence to determine which project the behavior is associated with and which task is being accomplished.

In some embodiments, the content categorizer 440 is configured to take the aggregate input from the context analyzer 410, the content vectorizer 420 and the content clusterizer 430 and classify which word or phrases are representative of all the associated content that the behaviors map to and try to identify if the behaviors and content vectors confidently allow the machine learning algorithm to identify that a particular content belongs to a particular project.

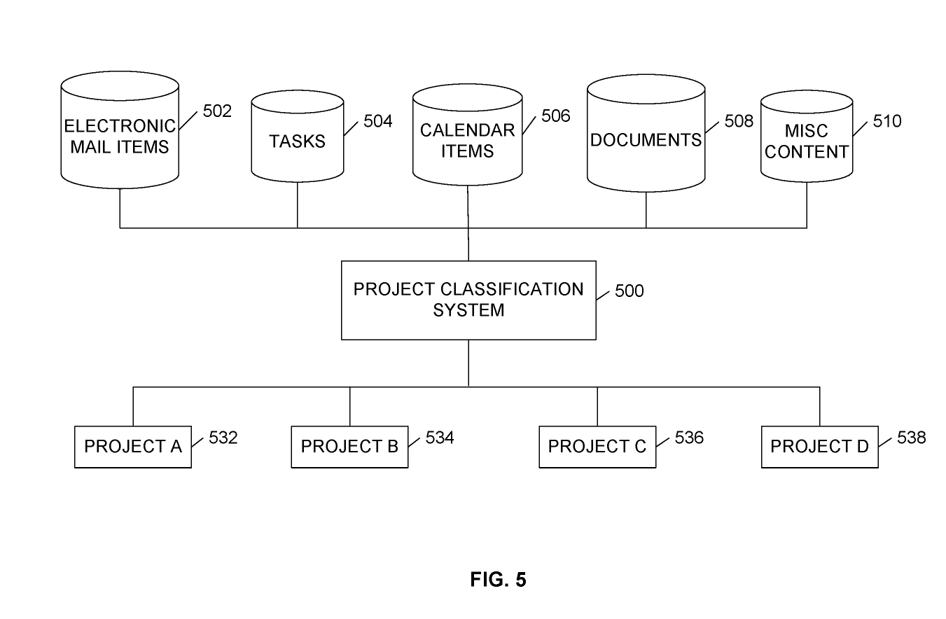

FIG. 5 is a block diagram illustrating an association between a number of electronic content repositories (for example, a database) and one or more electronic project workspaces via a project classification system. In the example shown, the electronic content repositories include an electronic mail items repository 502, a tasks repository 504, a calendar items repository 506, a documents repository 508, and a miscellaneous content repository 510. The electronic mail items repository 502 is illustrative of one or more electronic mail items that may be classified into a given project as described herein. In some embodiments, the electronic mail items in the electronic mail items repository 502 are classified upon a user's attempt to transmit an electronic mail item, or when the user receives and opens and electronic mail item. In some embodiments, the tasks repository 504 includes tasks generated and stored by a user or tasks received by the user from other users that are subsequently stored in a task database for the user. When a task item is stored by the user, the task item may be classified into a given project workspace, as described herein. In some embodiments, the calendar items repository 506 includes, for example, received and sent meeting requests, and the like. The calendar items may be recommended for a classification according to a given project workspace upon generation, sending, receiving, or accepting. In some embodiments, the documents repository 508 and the miscellaneous content repository 510 are illustrative of content generated and stored, or received by a user that may be classified into a given project workspace, as described herein. The project classification system 500 is configured to classify the content received from the various repositories namely 502, 504, 506, 508, 510 and for recommending and classifying the various content items into one or more project workspaces 532 (Project A), 534 (Project B), 536 (Project C), and 538 (Project D).

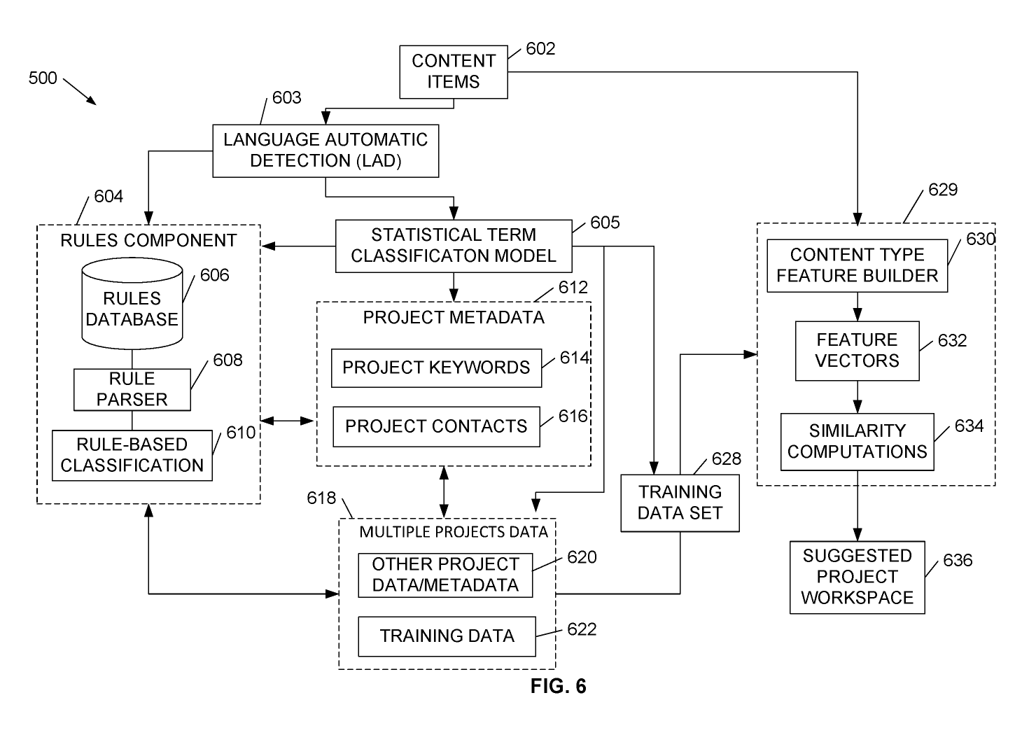

FIG. 6 illustrates a system architecture and process flow associated with automatically classifying electronic content into one or more electronic project workspaces. In some embodiments, the project classification system 500 is operative to cause the classification of one or more content items (shown in FIG. 5), into one or more prescribed project workspaces. For example, if a user is associated with four different project groups, each of which has a dedicated project workspace, each time the user generates and stores a content item, receives or sends a content item, or the like, the project classification system 500 classifies the content item into one of the user's four different example project workspaces. Alternatively, if the user is not associated with any project workspaces, the project classification system 500 is configured to propose a new project workspace to classify content items based on intrinsic data and/or extrinsic data associated with the content.

When a content item 602 is received for classification into a given workspace, text, data, and metadata contained in and/or associated with the content item 602 are processed for use by the project classification system 500. Received content and metadata are analyzed and formatted as necessary for text processing described below. In some embodiments, the content item processing may be performed by a text parser operative to parse text contained in the received content item and associated metadata for processing the into one or more text components (for example, sentences and terms comprising the one or more sentences). For example, if the content item 602 and associated metadata are formatted according to a structured data language, for example, Extensible Markup Language (XML), the content preparation may include parsing the retrieved content item 602 and associated metadata according to the associated structured data language for processing the text as described herein. For another example, the content item and associated metadata may be retrieved from an online source such as an Internet-based chat forum where the retrieved text may be formatted according to a markup language such as Hypertext Markup Language (HTML). In some embodiments, the content preparation includes formatting the received content item 602 and associated metadata from such a source so that it may be processed for content classification as described herein.

In some embodiments, the text included in the content item 602 and associated metadata is processed for classifying the content into a given workspace. A text processing application may be employed whereby the text is broken into one or more text components for determining whether the received/retrieved text contains terms that may be used in comparing to other classified content. Breaking the text into the one or more text components may include breaking the text into individual sentences followed by breaking the individual sentences into individual tokens for example, words, numeric strings, etc. Punctuation marks and capitalization contained in a text portion may be utilized for determining the beginning and ending of a sentence. Spaces contained between portions of text may be utilized for determining breaks between individual tokens, for example, individual words, contained in individual sentences.

In addition, alphanumeric strings following known patterns, for example, five digit numbers associated with zip codes, may be utilized for identifying portions of text. In addition, initially identified sentences or sentence tokens may be passed to one or more recognizer programs for comparing initially identified sentences or tokens against databases of known sentences or tokens for further determining individual sentences or tokens. For example, a word contained in a given sentence may be passed to a database to determine whether the word is a person's name, the name of a city, the name of a company, or whether a particular token is a recognized acronym, trade name, or the like. A variety of means may be employed for comparing sentences or tokens of sentences against known, words, or other alphanumeric strings for further identifying those text items.

After the content item 602 has been processed for classification, the content item 602 may be classified for inclusion into a given project workspace according to a rules classification system, a project metadata classification system, and a keywords and phrases classification system, or a combination thereof. In some embodiments, after the content item 602 is passed through a language automatic detection (LAD) application 603. The language automatic detection application 603 is used before processing the content item 602 for classification because the classification rules, described below, may be different for different languages, and thus, the rules will perform better if a language to which the rules apply is known. Additionally, any text processing, such as breaking content into individual tokens, sentences, and/or words, may be language specific. In some embodiments, the received content item 602 may be passed directly to the rules component 604 or statistical classification model 605, described below, without passing through the language automatic detection application 603. The rules component 604 includes a rules database 606, a rule parser 608, and a rule-based classification application 610. The rules database 606 is a repository of rules that may be used to classify a given content item based on one or more specific criteria. For example, if the title of the content item contains the same name as a given project name, then a given rule in the rules database 606 may include automatically recommending the content item for the project bearing the same name. In another example, the rule might include recommending a content item generated by a particular user to a particular project workspace, when the particular user is in frequent contact with another user regarding a particular subject. In another example, a rule might include a rule based on timing associated with the content item and communication with other users around the same time.

The rule parser 608 is an application that parses the rules contained in the rules database 606 for comparison of those rules to terms extracted from the content item via text processing and content analysis described above. The rule-based classification application 610 applies the rules to process text and metadata associated with the content item 602 for determining whether a rule is met with regard to classifying the content item 602 in a given project workspace.

In some embodiments, in addition to the use of a rule-based classification system as described above, a statistical term classification model 605 for identifying parts of a content item as belonging to a given classification may be used. For example, a statistical model known as part-of-speech tagging or grammatical tagging may be used where components of a text-based content item may be characterized based on a location and contextual association with other components of the text component. Thus, for example, according to part-of-speech (POS), a word normally operating as a noun may be classified as a verb owing to its location between to known nouns and owing to the context of the words. Such a POS system may be used as an alternative to the rule-based system described above. Alternatively, the two systems may be combined to enhance classification efficiency.

As illustrated in FIG. 6, the output from the statistical term classification model 605 may be passed to components 604, 612, and 618 for further processing as described herein, or the output from the statistical term classification model 605 may go directly to the training data set component 628 as described below, or output may be passed through a combination of these components as desired for varying levels of classification determination.

Referring now to project metadata component 612, metadata associated with the content item, for example, content title, content author, content location, data/time of content generation and storage, data/time of content item transmission or receipt, metadata associating the content item with other content items, metadata associating the content item with other project workspaces, and the like may be utilized for recommending classification of a given content item into a given project workspace. The project keywords component 614 and the project contacts component 616 may be utilized for associating metadata, keywords, terms, features, and the like extracted from the content item and for associating or comparing those items through contact information or other identifying information associated with one or more project workspaces for recommending classification of a given content item into a particular project workspace. For example, if the content item includes an electronic email item bearing a sender name, one or more receiver names, a title, and the like that may be matched to similar metadata associated with other electronic mail items previously classified into a particular workspace, that information may be used by the project classification system 500 for recommending inclusion of the example electronic mail item with the particular project workspace.

In some embodiments, at the multiple projects data component 618, content and metadata extracted from the content items may be utilized by the project classification system 500 for proposing recommending classification for a given content item into a particular project workspace. According to embodiments, the multiple projects data component 618 provides an access point to other project data/metadata 620 and training data 622 associated with content items previously classified into one or more other project workspaces, for example, the project workspaces 532, 534, 536, 538, illustrated in FIG. 5. For example, a document previously assigned to a given project workspace will have various data comprising the document including text, images, numeric data, and the like that was processed for analysis and classification when that document was previously classified in a given workspace. In addition, during the classification process, training data set 626 associated with the classification of that document may be generated. The training data set 626 may be used by the project classification system 500 in association with other project data and metadata for subsequently classifying a new content item by comparing data associated with the new content item with the project data and training data associated with content items stored in other project workspaces.

After the training data set 628 is generated for the current content item, classification is performed with classification component 629. The content type feature builder component 630 compares the information assembled for the content item 602 with similar information contained in or associated with content items previously classified into one or more other project workspaces. Once the current content item is found to be similar to content items previously classified into one or more other project workspaces, one or more other project workspaces may be proposed to a user as a suggested project 636. In some embodiments, if the user rejects the proposed classification then project classification system 500 may utilize the rejection to cause the project classification system 500 to analyze the information again and to propose a different classification. In some embodiments, if the user proposes a new project workspace classification for the content item 602, then the project classification system 500 may parse the information contained in content items associated with the project workspace proposed by the user to compare with data extracted from and obtained in association with the current content item for enhancing its ability to make project workspace suggestions on future similar content items.

Referring still to FIG. 6, when a new content item is received, before processing the content item through the rules component 604, the project metadata component 612, and/or multiple projects data component 618, the content may be passed directly to the classification component 629 to determine whether the content item is so similar to content items previously classified into a given project workspace that additional analysis is not required. For example, an electronic mail item that is a simple response to a previous electronic mail item already classified under a particular project workspace may be passed directly to the classification component 629 for similarity analysis (at 634) and for project classification recommendation. In other words, if the information comprising the example electronic mail content item, such as sender name, recipient name, date/time of transmission, subject line, etc. indicate that the new content item is so similar to previous content items already classified under a given project workspace, the example electronic mail content item may be proposed for classification into that project workspace.

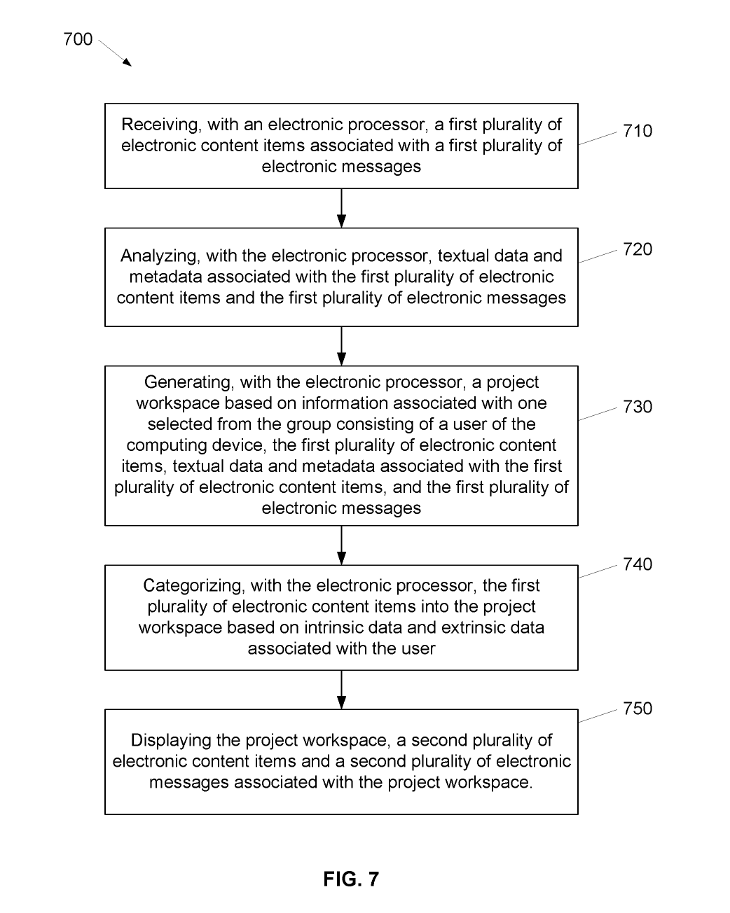

FIG. 7 is a flow chart of a method 700 for categorizing electronic content, in accordance with some embodiments. At block 710, the method 700 includes receiving, with the electronic processor 110, electronic content items 602 associated with electronic messages. In some embodiments, receiving the electronic content items includes receiving various electronic documents. In some embodiments, receiving the electronic content items 602 includes receiving meeting information, task information or a calendar information associated with the user of the computing device 102 or a project the user is working on. In some embodiments, receiving the electronic content items 602 includes receiving an electronic mail, text message or other notifications from various other software applications. In some embodiments, receiving the electronic content items 602 includes receiving information related to a social networking application associated with the user.

At block 720, the method 700 includes analyzing, with the electronic processor 110, textual data and metadata associated with the electronic content items 602 and the electronic messages. In some embodiments, analyzing the textual data and metadata associated with the electronic content items 602 includes determining whether textual data or metadata associated with electronic content items 602 matches one or more previously classified electronic content items within a project workspace 636. In some embodiments, analyzing the textual data and metadata associated with the electronic content items 602 includes determining whether textual data or metadata comply with one or more rules for classifying the electronic content items 602.

At block 730, the method 700 includes generating, with the electronic processor 110, the project workspace 636 based on information associated with one selected from the group consisting of a user of the computing device 102, electronic content items 602, textual data and metadata associated with electronic content items 602 and the electronic messages.

At block 740, the method 700 includes categorizing, with the electronic processor 110, the electronic content items 602 into the project workspace 636 based on intrinsic data and extrinsic data associated with the user. In some embodiments, the method 700 includes classifying the electronic content items 602 into a project workspace 636 based on a determination that textual data contained in the electronic content items matches one or more previously identified electronic content items within a project workspace 636. In some embodiments, the method 700 includes classifying the electronic content items 602 into the project workspace 636 based on a determination that metadata associated with electronic content items 602 matches one or more previously classified electronic content items in the project workspace 636. In some embodiments, the method 700 includes classifying the electronic content items 602 into the project workspace 636 when textual data or metadata for the electronic content items 602 comply with one or more rules for classifying the electronic content items 602. In one embodiment, the one or more rules for classifying the electronic content items 602 into project workspaces 626 may be generated by the user of the computing device 102. In another embodiment, the one or more rules for classifying the electronic content items 602 into project workspaces 636 is automatically generated by the project classification system 500.

At block 750, the method 700 includes displaying the project workspace 636 and the electronic content item 606 and the electronic messages associated with the project workspace 636.

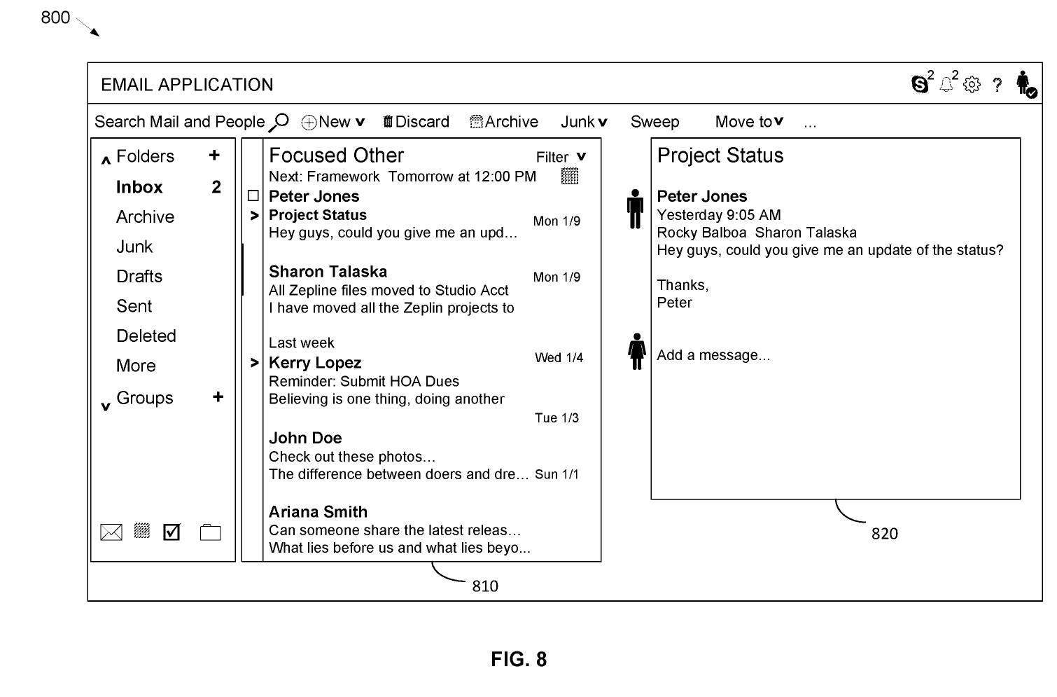

FIG. 8 illustrates a graphical user interface 800 of an electronic messaging application, in accordance with some embodiments. In the example shown in FIG. 8, the graphical user interface 800 shows a view of the inbox 810 of an email application with some conversations are mapped into a project workspace 820, which is named as “Project Status” in FIG. 8.

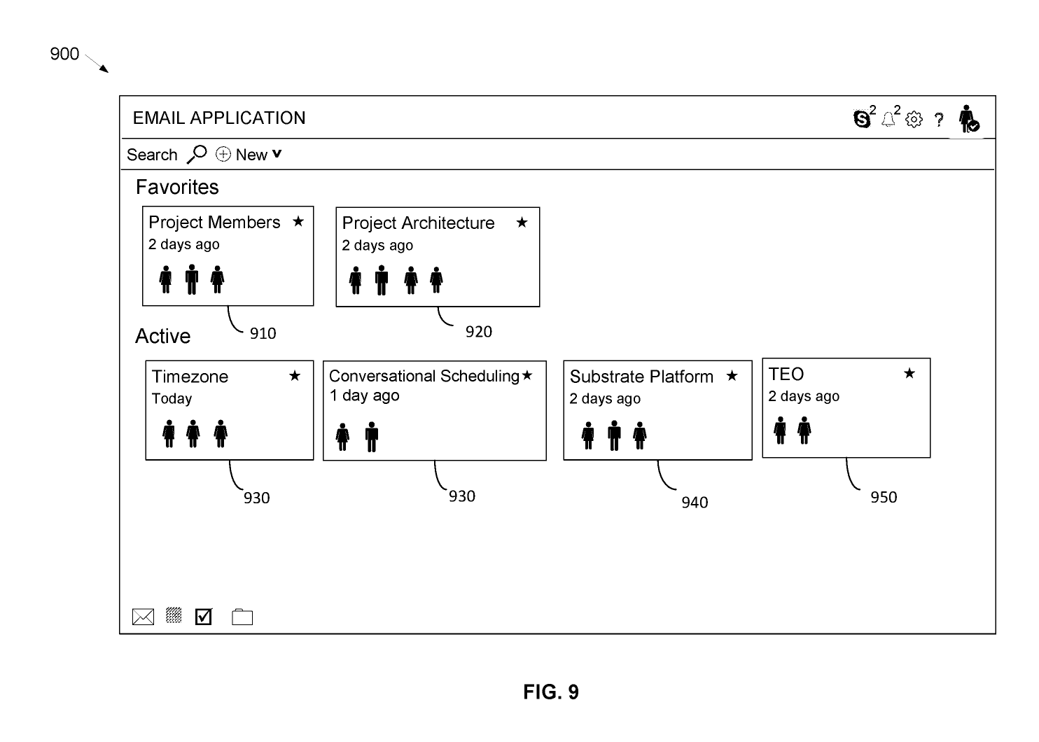

FIG. 9 illustrates a graphical user interface 900 of an electronic messaging application, in accordance with some embodiments. In the example shown in FIG. 9, the graphical user interface 900 shows a view of various project spaces that are categorized as either “Favorites” or as “Active”. The project workspace “Project Members” 910 and “Project Architecture” 920 are categorized as “Favorites”. Similarly, the project workspace “Timezone” 930, “Conversational Scheduling” 940, “Substrate Platform” 950, and “TEO” 960 are categorized as “Active”.

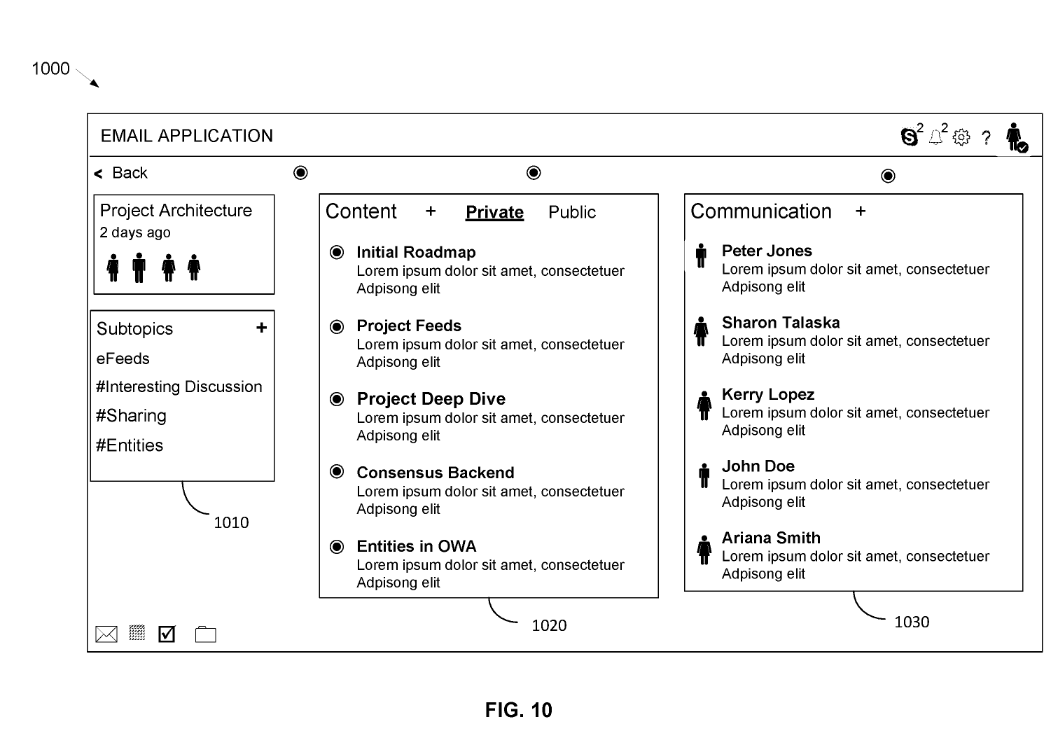

FIG. 10 illustrates a graphical user interface 1000 of an electronic messaging application, in accordance with some embodiments. In the example shown in FIG. 10, the graphical user interface 1000 shows a view of several fields 1010, 1020, and 1030 within a chosen project workspace “Project Architecture” 920. In some embodiments, field 1010 represents various subtopics associated with Project Architecture 920. In some embodiments, field 1020 shows a view of content items that are categorized under Project Architecture 920 based on privacy settings (for example, Private or Public). In the example, shown in FIG. 10, the content items are placed under the “Private” privacy setting. In some embodiments, field 1030 shows a various communication such as electronic messages that are categorized under Project Architecture 920.

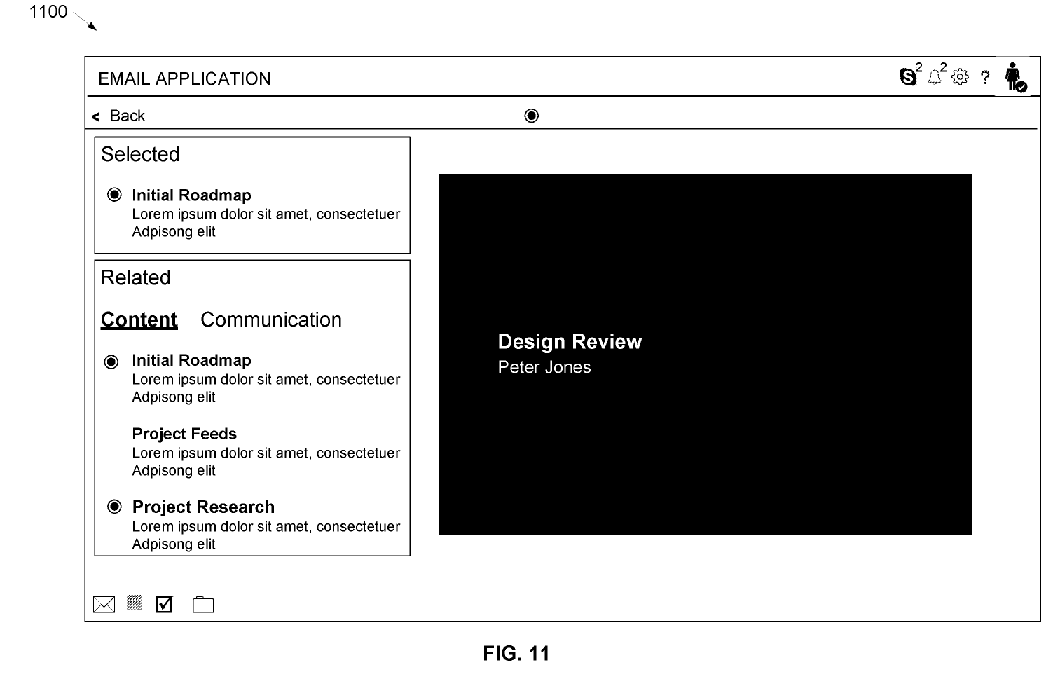

FIG. 11 illustrates a graphical user interface 1100 of an electronic messaging application, in accordance with some embodiments. The example in FIG. 11 shows an email that may be automatically labeled to belong to a particular project workspace.

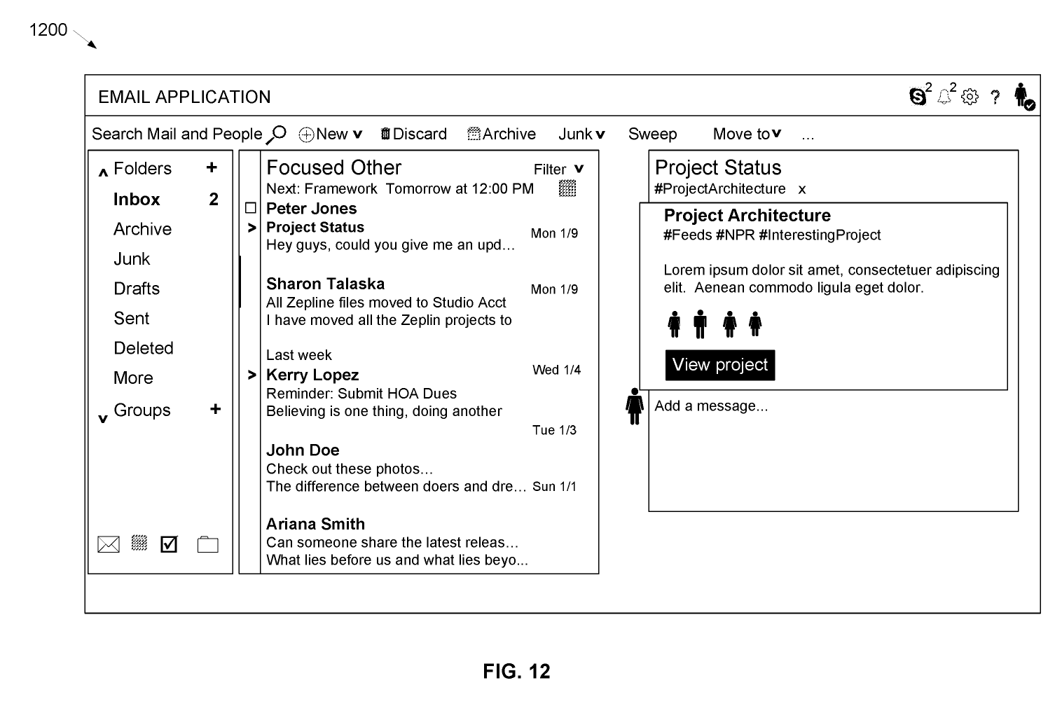

FIG. 12 illustrates a graphical user interface 1200 of an electronic messaging application, in accordance with some embodiments. The example in FIG. 12 shows an email that can be manually sent from the project workspace.

In some embodiments, the email server 106 may execute the software described herein, and a user may access and interact with the software application using the computing device 102. Also, in some embodiments, functionality provided by the software applications as described above may be distributed between a software application executed by a user's personal computing device and a software application executed by another electronic process or device (for example, a server 104) external to the computing device 102. For example, a user can execute a software application (for example, a mobile application) installed on his or her smart device, which may be configured to communicate with another software application installed on the email server 106.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Various features and advantages of some embodiments are set forth in the following claims.

What is claimed is:

1. A computing device, the computing device comprising:
a display-device displaying a graphical user interface; and
an electronic processor operatively coupled to the display, the electronic processor configured to
receive an electronic content item associated with an electronic message;
analyze textual data and metadata associated with the electronic content item and the electronic message;
generate a project workspace based on information associated with one selected from a group consisting of a user of the computing device, the electronic content item and the electronic message;
categorize the electronic content item into the project workspace based on an extrinsic data and an intrinsic data associated with the user; and
display the project workspace in the graphical user interface.

2. The computing device of claim 1, wherein the intrinsic data comprising data related to a characteristic associated with the user.

3. The computing device of claim 1, wherein the extrinsic data comprising data associated with an action taken by the user within a social group associated with the user.

4. The computing device of claim 1, wherein the project workspace further comprising a plurality of content items related to extrinsic and intrinsic data associated with the user.

5. The computing device of claim 1, wherein the project workspace comprising a plurality of groups, the plurality of groups associated with a plurality of privacy settings.

6. The computing device of claim 1, wherein the electronic content item is selected from the group consisting of an electronic document, a meeting request, a task item, a calendar item, an electronic mail, a text message, and data related to a social networking application associated with the user.

7. The computing device of claim 1, wherein the electronic processor configured to
classify the electronic content item into the project workspace based on a determination that one or more textual data contained in the electronic content item matches a previously classified electronic content item in the project workspace.

8. The computing device of claim 1, wherein the electronic processor configured to
classify the electronic content item into the project workspace based on a determination that one or more metadata associated with the electronic content item matches a previously classified electronic content item in the project workspace.

9. A method for categorizing electronic content, the method comprising:
receiving, with an electronic processor, a first plurality of electronic content items associated with a first plurality of electronic messages;
analyzing, with the electronic processor, a textual data and metadata associated with the first plurality of electronic content items and the first plurality of electronic messages;
generating, with the electronic processor, a project workspace based on information associated with one selected from the group consisting of a user of a computing device, the first plurality of electronic content items, textual data and metadata associated with the first plurality of electronic content items, and the first plurality of electronic messages;
categorizing, with the electronic processor, the first plurality of electronic content item and the first plurality of electronic messages into the project workspace based on intrinsic data and extrinsic data associated with the user; and
displaying the project workspace and a second plurality of electronic content items and a second plurality of electronic messages associated with the project workspace.

10. The method of claim 9, wherein receiving the first plurality of electronic content items comprises, receiving electronic content items selected from a group consisting of an electronic document, a meeting request, a task item, a calendar item, an electronic mail, text message, and data related to a social networking application associated with the user.

11. The method of claim 9, further comprising:
classifying the first plurality of electronic content items into the project workspace based on a determination that textual data contained in the first plurality of electronic content items matches one or more previously classified electronic content items in the project workspace.

12. The method of claim 9, further comprising:
classifying the first plurality of electronic content items into the project workspace based on a determination that metadata associated with the first plurality of electronic content items matches one or more previously classified electronic content items in the project workspace.

13. The method of claim 9, further comprising:
classifying the first plurality of electronic content items into the project workspace if textual data and metadata associated with the first plurality of electronic content items comply with a rule for classifying the first plurality of electronic content items.

14. The method of claim 13, further comprising:
storing the second plurality of electronic content items, the textual data and metadata associated with the second plurality of electronic content items with previously classified electronic content items and textual data and metadata associated with the previously classified electronic content items into the project workspace.

15. A non-transitory computer-readable medium containing computer-executable instructions that when executed by one or more processors cause the one or more processors to:
receive an electronic content item;
analyze textual data and metadata associated with the electronic content item;
generate a project workspace based on one selected from a group consisting of information associated with a user of a computing device, the textual data associated with the electronic content item, and metadata associated with the electronic content item;
categorize the electronic content item into the project workspace; and
display the project workspace.

16. The non-transitory computer-readable medium of claim 15, wherein the one or more electronic processors is configured to classify the electronic content item into the project workspace based on a determination that one or more textual data contained in the electronic content item match one or more previously classified electronic content items in the project workspace.

17. The non-transitory computer-readable medium of claim 15, wherein the one or more electronic processors is configured to
classify the electronic content item into the project workspace based on a determination that metadata associated with the electronic content item match one or more previously classified electronic content items in the project workspace.

18. The non-transitory computer-readable medium of claim 15, wherein the one or more electronic processors is configured to
classify the electronic content item into the project workspace if textual data and metadata for the electronic content item comply with one or more rules for classifying the electronic content item.
